(19) United States
(12) Patent Application Publication
(10) Pub. No.: US 2025/0053883 A1
(43) Pub. Date: Feb. 13, 2025

(54) LEARNING METHOD USING USER-CENTRIC AI

(71) Applicant: HAREX INFOTECH INC., Seoul (KR)

(72) Inventors: Kyung Yang PARK, Seoul (KR); Kyoung Jun LEE, Seoul (KR)

(73) Assignee: HAREX INFOTECH INC., Seoul (KR)

(21) Appl. No.: 18/720,789

(22) PCT Filed: Dec. 12, 2022
(86) PCT No.: PCT/KR2022/020126

§ 371 Date: Jun. 17, 2024

(30) Foreign Application Priority Data
Dec. 17, 2021 (KR) 10-2021-0181979
Nov. 14, 2022 (KR) 10-2022-0151707

(51) Int. Cl. G06N 20/20

(52) U.S. Cl. CPC G06N 20/20

(57) ABSTRACT

The present disclosure relates to a learning method using user-centric artificial intelligence. The learning method using user-centric artificial intelligence according to the present disclosure includes (a) executing learning using data in a plurality of local domains, (b) building a global model using the learning result in the plurality of local domains, and (c) transmitting the global model to the local domain, additionally executing learning, and then transmitting the global model to the center.

### BACKGROUND

### 1. Technical Field

The present disclosure relates to a learning method using user-centric artificial intelligence.

### 2. Related Art

The concept of user-centric artificial intelligence (AI) has been presented as a model of next-generation artificial intelligence that protects users' privacy and creates new transactions. The user-centric AI service is defined as an artificial intelligence service that can achieve the intended result while at the same protecting the privacy of an individual user and enabling collaboration that maximizes the information protection of corporate (organizational) users.

As an example, an algorithm has been ever proposed, which recommends by reflecting purchase information from other stores to compensate for insufficient data in terms of a single store by using only purchase information without using the user's personal information, and through this, it is possible to provide a user-centric payment sharing platform-based service. In more detail, it is not a structure in which the user's financial information is transmitted to the affiliate and connected to the financial institution from the affiliate's system. Since the affiliate's ID is transmitted to the user's system and the payment service is processed in the user's system (e.g., smartphone), the payment can be made without the intervention of an intermediary between the paying user and the financial institution, so that the user's personal information is not unnecessarily transmitted to business operators, and rather, business operator information is accumulated in the user's system, and a basis for user-centric services is created.

According to the prior art, in building an artificial intelligence model by collecting learning results from a plurality of domains, since the learning result for all data in each domain is received and the model is simply integrated, there is a limit in that the different environments and characteristics of each domain are not considered.

### SUMMARY

The present disclosure has been proposed to solve the above problems, and proposes a data/model transmission/reception method through a user-centric artificial intelligence protocol (UCAI Protocol) between a plurality of local domains and a center, and through this, the purpose is to provide a learning method using user-centric artificial intelligence capable of deriving a highly reliable global model.

The learning method using user-centric artificial intelligence according to the present disclosure includes (a) executing learning using data in a plurality of local domains, (b) building a global model using the learning result in the plurality of local domains, and (c) transmitting the global model to the local domain, additionally executing learning, and then transmitting the global model to the center.

The step (a) includes standardizing an artificial intelligence model in the plurality of local domains, receiving an initial value of the artificial intelligence model from the center, and executing the learning using some data according to a predetermined criterion among acquired data.

The predetermined criterion is determined in consideration of a communication cost between the center and the local domain.

The step (b) includes building the global model by using information about data, learning results received from the plurality of local domains.

The information about the data includes a ratio of data used for learning among data obtained in the local domain and a number of data used for the learning.

The step (c) includes transmitting the global model to a new local domain, and the new local domain receives the global model and compares the global model with its own local model.

According to the present disclosure, by performing data/model transmission and reception through a user-centric artificial intelligence protocol, and by repeating the process of deriving a global model at the center based on the learning result using the amount of data corresponding to a certain standard in each local domain, there is an effect of being capable of deriving a highly reliable global model considering different environments and characteristics of a plurality of domains.

The effects of the present disclosure are not limited to those mentioned above, and other effects not mentioned will be clearly understood by those skilled in the art from the description below.

### BRIEF DESCRIPTION OF THE DRAWINGS

FIG. 1 shows a learning system using user-centric artificial intelligence according to an embodiment of the present disclosure.

FIG. 2 shows a global model and a local model according to an embodiment of the present disclosure.

FIG. 3 shows a combination of artificial intelligence models according to an embodiment of the present disclosure.

FIG. 4 shows an ensemble of a global model and a local model according to an embodiment of the present disclosure.

FIG. 5 shows a learning method using user-centric artificial intelligence according to an embodiment of the present disclosure.

FIG. 6 is a block diagram illustrating a computer system for implementing the driving method according to an embodiment of the present disclosure.

### DETAILED DESCRIPTION

and Above-described d objects and other objects, advantages and characteristics of the disclosure, and methods of achieving them will become apparent with reference to the embodiments described below in detail in conjunction with the accompanying drawings.

However, the present disclosure is not limited to the embodiments disclosed below, but will be implemented in a variety of different forms, and the following embodiments are merely provided to easily inform those skilled in the art of the purpose, configuration and effects of the disclosure, and the scope of the patent right of the present disclosure is defined by the description of the claims.

Meanwhile, as used herein, the terms are for the purpose of describing the embodiments, and are not intended to limit the present disclosure. Herein, terms in the singular form also relate to the plural form unless specifically stated otherwise in the context. As used herein, the terms “comprises” and/or “comprising” specify the presence of stated components, steps, operations, and/or elements, but do not preclude the presence or addition of at least one other component, step, operation, and/or element.

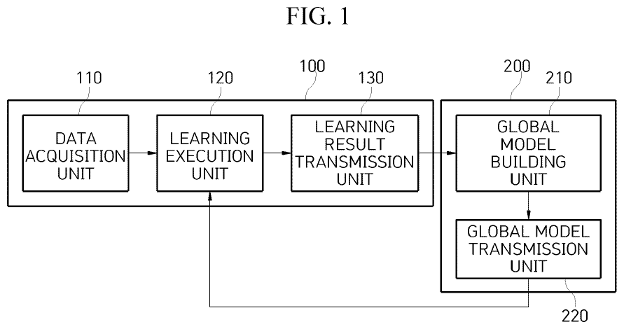

FIG. 1 shows a learning system using user-centric artificial intelligence according to an embodiment of the present disclosure.

The local node 100 includes a data acquisition unit 110, a learning execution unit 120, and a learning result transmission unit 130, and the center 200 includes a global model building unit 210 and a global model transmission unit 220.

The data acquisition unit 110 acquires data for learning, the learning execution unit 120 executes learning using some data according to a predetermined criterion among the acquired learning data, and the learning result transmission unit 130 transmits the learning result to the center 200. When the learning result transmission unit 130 transmits the learning result, information about what percentage of data of the local node has been learned, and information about the number of data for which learning has been executed are transferred together.

Although one local node is shown in FIG. 1, the local node exists for each different domain, and the center 200 receives learning results from a plurality of local nodes. The global model building unit 210 builds a global model using the learning result received from the local node. A process is repeated in which the global model transmission unit 220 transmits the built global model to each local node, and the learning execution unit 120 of the local node 100 additionally executes learning using data while using the received global model, and the learning result transmission unit 130 transmits such learning result to the center 200 again.

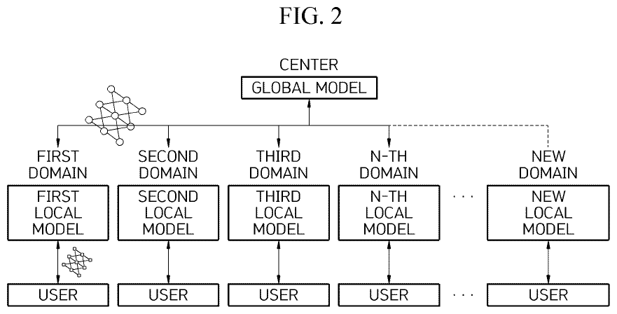

FIG. 2 shows a global model and a local model according to an embodiment of the present disclosure.

In a first domain, a second domain, . . . , and an N-th domain, a first local model, a second local model, . . . , and an N-th local model are created, respectively.

The respective local models are N subjects, and as data is generated in each subject, the artificial intelligence model (local model) of each subject is standardized, and the center transmits the initial values of these models to each subject. Each subject sends the result of learning a part of its data (e.g., 5% of data according to a preset standard) to the center, and the center sends a model resulting from the combination of such learning results back to each subject.

The center receives each local model learning result, builds a new global model, and regularly or irregularly updates toward the local domain using the built global model.

Regarding the sharing of learning results between each local model and the global model, if the communication cost between the center and the local node is less than a certain standard, the local node cuts the data very finely and sends some of the learning results to the center. At this time, the local node transmits information about what percentage of its data it has been learned is sent as the result, and information about the number of data for which learning has been executed, together. Through this process, it is possible for the center to perform a fair averaging.

As for the protocol strategy between the center (global) and the local node, the time zone, the number of times of sharing the learning results, etc. are set differently for each local node, and a protocol strategy suitable for the situation of each local node is established. For example, it is possible that the control of the center may be executed through a very strong hierarchical and sequential protocol, or through a protocol in which the local node complies with certain rules and acts autonomously. In this case, the local node can establish a strategy used in each local domain by combining the past global model, the past local model, the current local model, and the most recently received global model. The center executes a function of ensemble models received from the local nodes.

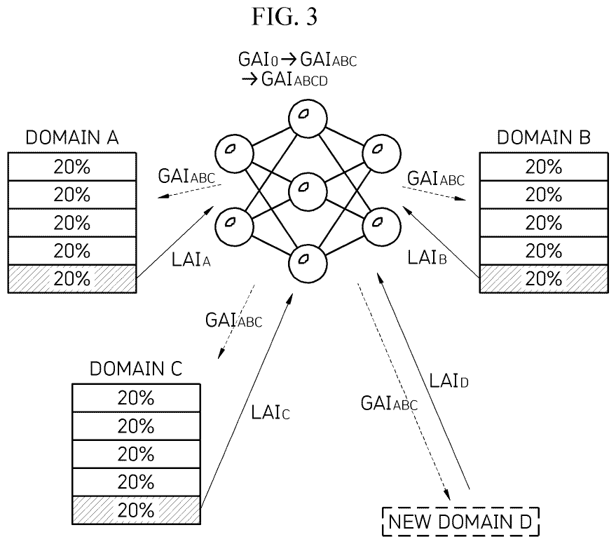

FIG. 3 shows a combination of artificial intelligence models according to an embodiment of the present disclosure.

The local domain is shown assuming that domain A, domain B, and domain C exist.

The first global model is shown as GAI₀. Each local node transmits the local model (LAI_{A}, LAI_{B}, LAI_{C}), which is the result of learning with the data of each domain's preset standard (e.g., 20%), to the center. The center receives the learning results, creates a global model (GAI_{ABC}), and sends it to each local node. Each local node receives the global model, and transmits the result of additionally learning the data of the preset criteria (e.g., additional 20% of data) back to the center. That is, the global model built using the results of learning with 20% data in each of the domain A, the domain B, and the domain C may be defined as GAI_{ABC-1}, and in a subsequent turn, the global model built by combining the learning results by adding 20% data can be defined as GAI_{ABC-2}, and by repeating this process, the GAI_{ABC-N} model is finally derived (Through the above process, the transmission of the learning result using 20% of the data and the global model building through the learning result collection are repeated 5 times, so the GAI_{ABC-5} global model is finally derived).

When a new domain, the domain D, appears, the local node of the domain D receives the GAI_{ABC} global model, and compares it with the local model LAI_{D}.

The comparisons of GAI₀ and LAI_{A}, the comparison of GAI_{ABC}, GAI_{AB}, GAI_{BC}, GAI_{AC} and the like is made.

According to an embodiment of the present disclosure, it is possible to dynamically change the learning sequence, and establish a learning method similar to dynamic programming.

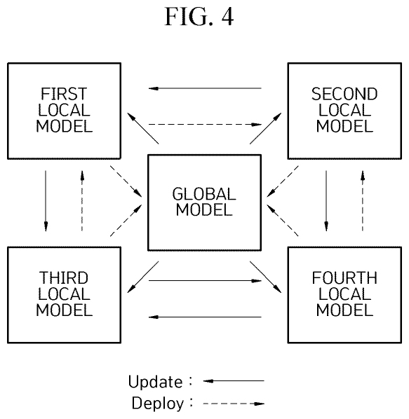

FIG. 4 shows an ensemble of a global model and a local model according to an embodiment of the present disclosure.

FIG. 4 shows an example of ensembling a local model and a global model from the standpoint of a local operator using a user-centric artificial intelligence service according to an embodiment of the present disclosure.

The first to fourth local models and the global model mutually execute deployment and update.

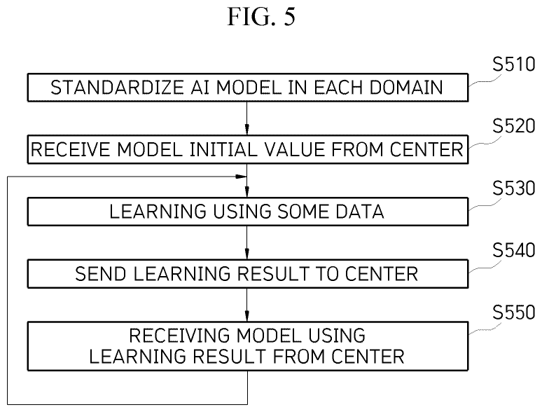

FIG. 5 shows a learning method using user-centric artificial intelligence according to an embodiment of the present disclosure.

In step S510, the local node of each local domain standardizes an artificial intelligence model (local model).

In step S520, the local node receives a model initial value from the center.

In step S530, the local node executes learning using data (e.g., 20% of data) corresponding to a predetermined criterion among data it has.

In step S540, the local node transmits the learning result to the center. At this time, the local node transmits information about what percentage of the data thereof has been learned, and information about the number of data for which learning has been executed. The center builds a global model for each version using the learning results received from the respective local nodes.

In step S550, the local node receives the global model from the center, and the process returns to step S530, and then the process of additionally performing learning using data corresponding to the predetermined criterion (e.g., additional 20% of data) is repeated. Subsequently, in step S540, the learning results are transmitted to the center, and the center builds a global model for each version using the learning results.

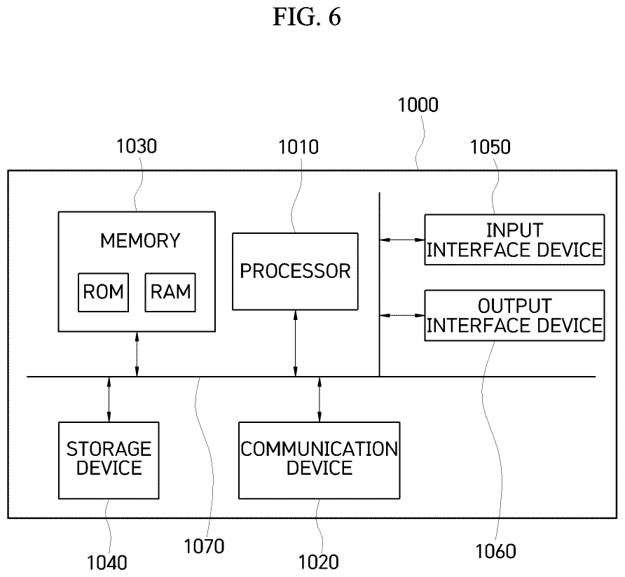

FIG. 6 is a block diagram illustrating a computer system for implementing the driving method according to an embodiment of the present disclosure.

Referring to FIG. 6, a computer system 1000 may include at least one of a processor 1010, memory 1030, an input interface device 1050, an output interface device 1060, and a storage device 1040, which communicate with each other through a bus 1070. The computer system 1300 may also include a communication device 1020 that is connected to a network. The processor 1010 may be a central processing unit (CPU) or may be a semiconductor device that executes an instruction stored in the memory 1030 or the storage device 1040. The memory 1030 and the storage device 1040 may each include volatile or non-volatile storage media having various forms. For example, the memory may include read only memory (ROM) and random access memory (RAM). In an embodiment of this specification, the memory may be disposed inside or outside the processor. The memory may be connected to the processor through various means that have already been known. The memory includes volatile or non-volatile storage media having various forms. The memory may include ROM or RAM, for example.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform method according to at least one aspect of this writing.

The communication device 1020 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes of those skilled in the art using the basic concept of the present disclosure defined in the appended claims are also included in the scope of rights of the present disclosure.

What is claimed is:

1. A learning method using user-centric artificial intelligence, the learning method comprising:
(a) executing learning using data in a plurality of local domains;
(b) building a global model using the learning result in the plurality of local domains; and
(c) transmitting the global model to the local domain, additionally executing learning, and then transmitting the global model to a center.

2. The learning method of claim 1, wherein the step (a) includes: standardizing an artificial intelligence model in the plurality of local domains, receiving an initial value of the artificial intelligence model from the center, and executing the learning using some data according to a predetermined criterion among acquired data.

3. The learning method of claim 2, wherein the predetermined criterion is determined in consideration of a communication cost between the center and the local domain.

4. The learning method of claim 1, wherein the step (b) includes building the global model by using information about data, learning results received from the plurality of local domains.

5. The learning method of claim 4, wherein the information about the data includes a ratio of data used for learning among data obtained in the local domain and a number of data used for the learning.

6. The learning method of claim 1, wherein the step (c) includes transmitting the global model to a new local domain, and the new local domain receives the global model and compares the global model with its own local model.
